(19) United States
(12) Patent Application Publication
(10) Pub. No.: US 2012/0087536 A1
(43) Pub. Date: Apr. 12, 2012

(54) SPEAKER UNIT AND ACTIVE SPEAKER DEVICE

(75) Inventors: Kouji Miyata, Kanagawa (JP); Makoto Kawabata, Tokyo (JP)

(73) Assignee: SONY CORPORATION, Tokyo (JP)

(21) Appl. No.: 13/238,186

(22) Filed: Sep. 21, 2011

(30) Foreign Application Priority Data
Oct. 6, 2010 (JP) P2010-226277

(51) Int. Cl. H04R 1/00

(52) U.S. Cl. 381/407

(57) ABSTRACT

A speaker unit performing sound output in proportion to electric current by current driving includes: a frame having an opening; a magnet arranged inside the frame and formed in an annular shape; a yoke including a shaft-shaped insertion arrangement portion which is inserted into a center of the magnet; a coil bobbin formed in a cylindrical shape; a coil wound around an outer peripheral surface of the coil bobbin; a damper having elasticity and connected between the frame and the coil bobbin; and a cone connected to the coil bobbin at an inner peripheral portion and fixed to an opening edge of the opening of the frame at an outer peripheral portion, which vibrates with movement of the coil bobbin, wherein a communicating hole communicating the inside to the outside is formed at the frame, and a portion of the communicating hole is blocked by an attachment member.

### CROSS-REFERENCE TO RELATED APPLICATION

The present application claims priority from Japanese Patent Application No. JP 2010-226277 filed in the Japanese Patent Office on Oct. 6, 2010, the entire content of which is incorporated herein by reference.

### FIELD

The present disclosure relates to a technical field concerning a speaker unit and an active speaker device. In particular, the present disclosure relates to a technical field of suppressing oscillation in the lowest resonance frequency domain by blocking a portion of a communicating hole formed in a frame by using an attachment member.

### BACKGROUND

There exists an active speaker device including an amplifier and a speaker unit outputting sound amplified by the amplifier.

As the speaker unit, for example, there exists the one in which a magnetic circuit including a magnet, a yoke and a coil is used and sound amplified by the amplifier is outputted (refer to, for example, JP-A-2006-229520 (Patent Document 1)).

In such speaker unit, the yoke is arranged at the center of an annular magnet, a coil wound about an outer peripheral surface of a tubular coil bobbin is arranged in a magnetic gap formed between the yoke and the magnet. The coil bobbin can be moved with respect to the yoke in the state where part of the coil bobbin is fitted onto the yoke, a cone is attached to one end of the coil bobbin as well as a cap blocking an internal space of the coil bobbin is attached to one end of the coil bobbin. A flexible damper is also attached to the coil bobbin.

In the above speaker unit, the magnetic circuit is driven based on a sound signal outputted from the amplifier and the cone vibrates with the movement of the coil bobbin, then, sound is outputted. When the coil bobbin is moved, the damper is elastically deformed to thereby suppress excessive movement of the coil bobbin.

In such speaker units, there is a voltage-driven type speaker unit in which sound is outputted by voltage.

The voltage-driven type speaker unit is generally used, however, driving force for outputting sound depends on voltage in the voltage-driven type speaker unit, therefore, linearity between voltage and driving force is broken in many cases, which causes deterioration in sound quality due to the break in linearity.

For example, electric current hardly flows in the coil as a frequency domain becomes higher in the voltage-driven type speaker unit, therefore, output (electromagnetic force) is reduced in high-frequency domains.

In order to compensate the reduction of output in high-frequency domains, the above-mentioned cap with certain rigidity is attached to one end of the coil bobbin and resonance is generated in the vicinity of the cap to amplify vibration, which suppress the reduction of output in high-frequency domains.

On the other hand, the damper is elastically deformed with the movement when the coil bobbin is moved in the voltage-driven type speaker unit. At this time, induced electromotive force is generated by electric current supplied to the coil, and so-called electromagnetic brake suppressing deformation of the damper is generated based on the induced electromotive force. Accordingly, oscillation by the resonance in the lowest resonance frequency domain based on the deformation of the damper can be suppressed.

In response to the above, there is a current-driven type speaker unit in which sound is outputted by electric current in the speaker units.

### SUMMARY

A communicating hole for communicating the inside to the outside is formed in a frame of the speaker unit. The communicating hole is necessary for reducing pressure inside the frame on the back side of the cone as well as increasing sound in low frequencies. It is desirable that the opening area of the communicating hole is large for increasing sound in low frequencies.

However, as the opening area of the communicating hole is increased, the pressure inside the frame on the back side of the cone is reduced, therefore, the deformation amount of the damper with the movement of the coil bobbin is increased.

When the drive method is changed to the current driving in the structure of the voltage-driven type speaker unit, induced electromotive force is not generated in the current-driven type speaker unit, therefore, the electromagnetic brake suppressing deformation of the damper is not generated.

Accordingly, it is difficult to suppress oscillation by the resonance in the lowest resonance frequency domain based on the deformation of the damper, which causes deterioration in sound quality.

In view of the above, it is desirable to provide a speaker unit and an active speaker device suppressing oscillation in the lowest resonance frequency domain and improving sound quality.

An embodiment of the present disclosure is directed to a speaker unit performing sound output in proportion to electric current by current driving, which includes a frame having an opening which opens at least to an output direction of sound, a magnet arranged inside the frame and formed in an annular shape, a yoke including a shaft-shaped insertion arrangement portion which is inserted into a center of the magnet and arranged there, a coil bobbin formed in a cylindrical shape and can be moved in an axial direction of the insertion arrangement portion in a state where part of the coil bobbin is fitted onto the insertion arrangement portion of the yoke, a coil wound around an outer peripheral surface of the coil bobbin and arranged in a magnetic gap formed by the magnet and the insertion arrangement portion of the yoke, a damper having elasticity and connected between the frame and the coil bobbin, and a cone connected to the coil bobbin at an inner peripheral portion and fixed to an opening edge of the opening of the frame at an outer peripheral portion, which vibrates with movement of the coil bobbin, in which a communicating hole communicating the inside to the outside is formed at the frame, and a portion of the communicating hole is blocked by an attachment member.

Therefore, pressure inside the frame on the back surface side of the cone is increased in the speaker unit.

It is preferable in the speaker unit that an opening area of a portion not blocked by the attachment member in the communicating hole is 40% or less of an area of the cone.

As the opening area of the portion not blocked by the attachment member in the communicating hole is 40% or less of the area of the cone, high pressure inside the frame can be secured.

It is preferable in the speaker unit that the attachment member is made of materials other than metal materials.

As the attachment member is made of materials other than metal materials, reflection coefficient of sound in the frame is reduced.

It is preferable in the speaker unit that the attachment member is made of materials having air permeability.

As the attachment member is made of materials having air permeability, occurrence of wind noise which can be generated as abnormal noise is suppressed.

It is preferable in the speaker unit that the attachment member is made of materials not having air permeability.

As the attachment member is made of materials not having air permeability, pressure inside the frame is easily increased.

Another embodiment of the present disclosure is directed to an active speaker device including an amplifier performing sound output in proportion to electric current by current driving, and a speaker unit outputting sound amplified by the amplifier, in which the speaker unit performing sound output in proportion to electric current by current driving includes a frame having an opening which opens at least to an output direction of sound, a magnet arranged inside the frame and formed in an annular shape, a yoke including a shaft-shaped insertion arrangement portion which is inserted into a center of the magnet, a coil bobbin formed in a cylindrical shape and can be moved in an axial direction of the insertion arrangement portion in a state where part of the coil bobbin is fitted onto the insertion arrangement portion of the yoke, a coil wound around an outer peripheral surface of the coil bobbin and arranged in a magnetic gap formed by the magnet and the insertion arrangement portion of the yoke, a damper having elasticity and connected between the frame and the coil bobbin, and a cone connected to the coil bobbin at an inner peripheral portion and fixed to an opening edge of the opening of the frame at an outer peripheral portion, which vibrates with movement of the coil bobbin, in which a communicating hole communicating the inside to the outside is formed at the frame, and a portion of the communicating hole is blocked by an attachment member.

Therefore, the pressure inside the frame on the back surface side of the cone is increased in the active speaker device.

The speaker unit according to the embodiment of the present disclosure performs sound output in proportion to electric current by current driving, which includes the frame having the opening which opens at least to the output direction of sound, the magnet arranged inside the frame and formed in an annular shape, the yoke including the shaft-shaped insertion arrangement portion which is inserted into the center of the magnet and arranged there, the coil bobbin formed in a cylindrical shape and can be moved in the axial direction of the insertion arrangement portion in the state where part of the coil bobbin is fitted onto the insertion arrangement portion of the yoke, the coil wound around the outer peripheral surface of the coil bobbin and arranged in the magnetic gap formed by the magnet and the insertion arrangement portion of the yoke, the damper having elasticity and connected between the frame and the coil bobbin, and the cone connected to the coil bobbin at the inner peripheral portion and fixed to the opening edge of the opening of the frame at the outer peripheral portion, which vibrates with movement of the coil bobbin, in which the communicating hole communicating the inside to the outside is formed at the frame, and the portion of the communicating hole is blocked by the attachment member.

As the opening area of the portion not blocked by the attachment member in the communicating hole is smaller than the area of the cone, pressure inside the frame is high and oscillation due to resonance in the lowest resonance frequency domain can be suppressed and sound quality can be increased.

According to the embodiment of the present disclosure, the opening area of the portion not blocked by the attachment member in the communicating hole may be 40% or less of the area of the cone.

Therefore, high pressure inside the frame can be secured and the effect of suppressing oscillation in the lowest resonance frequency domain can be increased.

According to the embodiment of the present disclosure, the attachment member may be made of materials other than metal materials.

Therefore, generation of reflected sound can be suppressed and sound quality can be increased.

According to the embodiment of the present disclosure, the attachment member may be made of materials having air permeability.

Therefore, occurrence of wind noise which can be generated as abnormal noise is suppressed and sound quality can be increased due to the reduction of noise.

According to the embodiment of the present disclosure, the attachment member may be made of materials not having air permeability.

Therefore, pressure inside the frame is easily increased and the effect of suppressing oscillation in the lowest resonance frequency domain can be further increased.

The active speaker device according to the embodiment of the present disclosure includes the amplifier performing sound output in proportion to electric current by current driving, and the speaker unit outputting sound amplified by the amplifier, in which the speaker unit performing sound output in proportion to electric current by current driving includes the frame having the opening which opens at least to the output direction of sound, the magnet arranged inside the frame and formed in an annular shape, the yoke including the shaft-shaped insertion arrangement portion which is inserted into the center of the magnet, the coil bobbin formed in a cylindrical shape and can be moved in the axial direction of the insertion arrangement portion in the state where part of the coil bobbin is fitted onto the insertion arrangement portion of the yoke, the coil wound around the outer peripheral surface of the coil bobbin and arranged in the magnetic gap formed by the magnet and the insertion arrangement portion of the yoke, the damper having elasticity and connected between the frame and the coil bobbin, and the cone connected to the coil bobbin at an inner peripheral portion and fixed to the opening edge of the opening of the frame at an outer peripheral portion, which vibrates with movement of the coil bobbin, in which the communicating hole communicating the inside to the outside is formed at the frame, and the portion of the communicating hole is blocked by the attachment member.

As the opening area of the portion not blocked by the attachment member in the communication hole is smaller than the area of the cone, pressure inside the frame is high and oscillation due to resonance in the lowest resonance frequency domain can be suppressed, which improves sound quality.

### BRIEF DESCRIPTION OF THE DRAWINGS

FIG. 1 shows an embodiment of the present disclosure with FIG. 2 to FIG. 5, which is a block diagram of a sound output device;

FIG. 2 is a perspective view showing an active speaker device with a digital music player;

FIG. 3 is an enlarged perspective view of a speaker unit;

FIG. 4 is an enlarged cross-sectional view of the speaker unit; and

FIG. 5 is an enlarged side view of the speaker unit.

### DETAILED DESCRIPTION

Hereinafter, a speaker unit and an active speaker device according to an embodiment of the present disclosure will be explained with reference to the attached drawings.

In the embodiment shown below, the technology is applied to an active speaker device in which a digital music player (DMP) is loaded and sound of the DMP is outputted and a speaker unit included in the active speaker device.

However, the application range of the present disclosure is not limited to the active speaker device outputting sound of the DMP and the speaker unit included in the active speaker device. The present disclosure can be widely applied to other various types of active speaker devices and speaker units included therein as long as they are the current-driven type active speaker device and the speaker unit included therein.

In the following explanation, directions of up, down, front, back, left and right are shown by determining a direction toward which the speaker unit of the active speaker device faces as a front direction.

The directions of up, down, front, back, left and right are shown for convenience of explanation, and the present disclosure is not limitedly applied to the directions.

### [Whole Configuration]

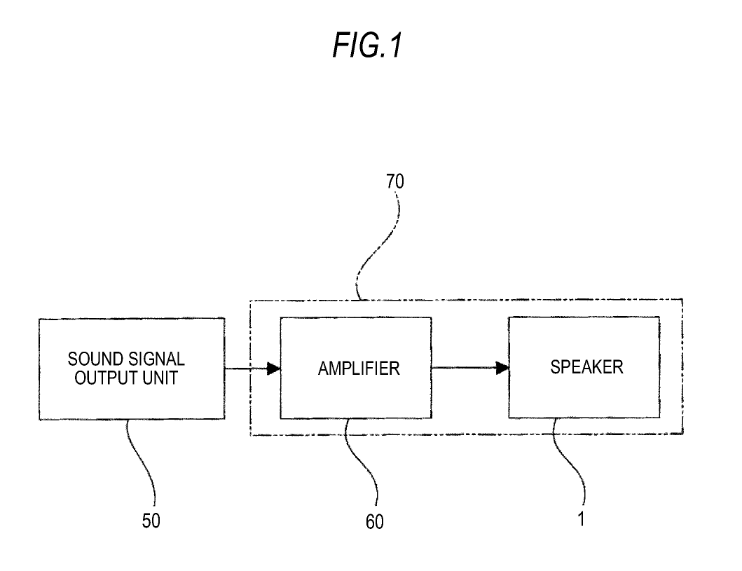

A speaker unit 1 has a function of outputting sound outputted from a sound signal output unit 50 such as a digital music player (DMP) and a disc player through an amplifier 60 (refer to FIG. 1).

Sound outputted from the audio signal output unit 50 is amplified by the amplifier 60 and outputted from the speaker unit 1. In the amplifier 60, sound output in proportion to electric current is performed by current driving.

An active speaker device 70 includes the amplifier and the speaker unit 1. It is preferable to that the active speaker device 70 includes plural speaker units 1.

The speaker unit 1 is included in the active speaker unit 70 with the amplifier 60.

### [Structure of the Active Speaker Device]

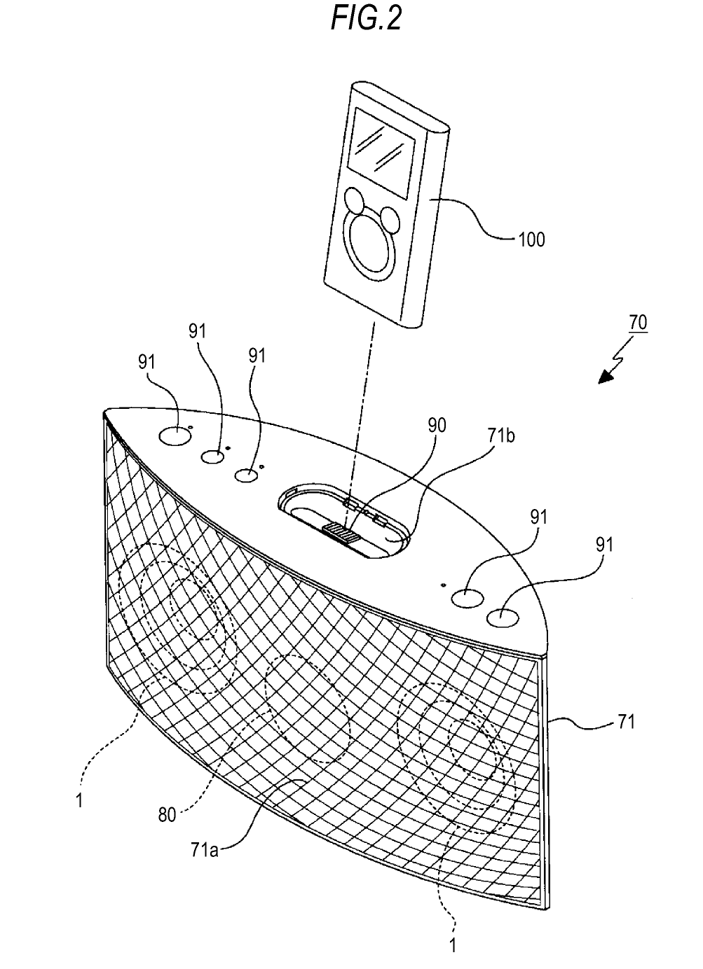

The active speaker device 70 includes a casing 71 and necessary respective parts arranged inside the casing 71 and on an outer surface side of the casing 71 (refer to FIG. 2).

On a front surface portion of the casing 71, a grill net 71a is formed.

The speaker units 1, 1 are arranged inside the casing 71 with an interval in a right-and-left direction. A not-shown sound path as a path for sound is formed inside the casing 71, and a sound output unit 80 called a bass reflex connecting to the sound path is arranged between the speaker units 1, 1. The sound output unit 80 has a function of enhancing bass sound.

A not-shown circuit substrate is arranged inside the casing 71. In the circuit substrate, an amplifier circuit functioning as the amplifier 60 is formed.

A loading hole 71b is formed at the center in the right and left direction on an upper surface portion of the casing 71 and a connector 90 is arranged in the loading hole 71b. On the upper surface portion of the casing 71, plural operation buttons 91, 91, . . . are arranged.

A digital music player (sound signal output unit 50) 100 is loaded in the loading hole 71b of the casing 71, and a not-shown connection terminal of the loaded digital music player 100 is connected to the connector 90.

As the connection terminal of the digital music player 100 is connected to the connector 90, sound outputted from the digital music player 100 can be outputted from the speaker units 1, 1 and the sound output unit 80.

### [Specific Structure of the Speaker Unit]

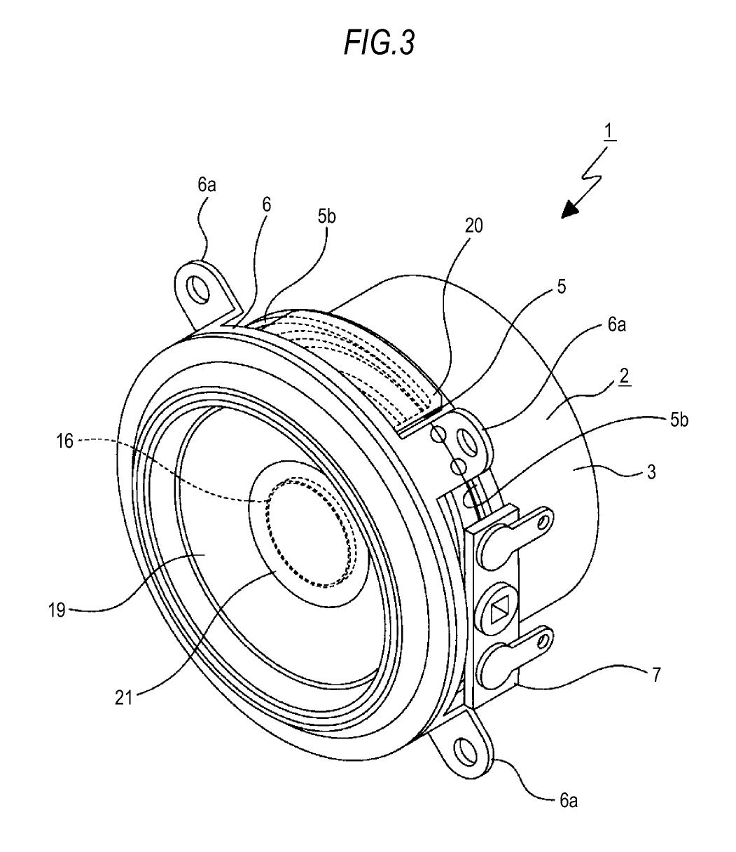

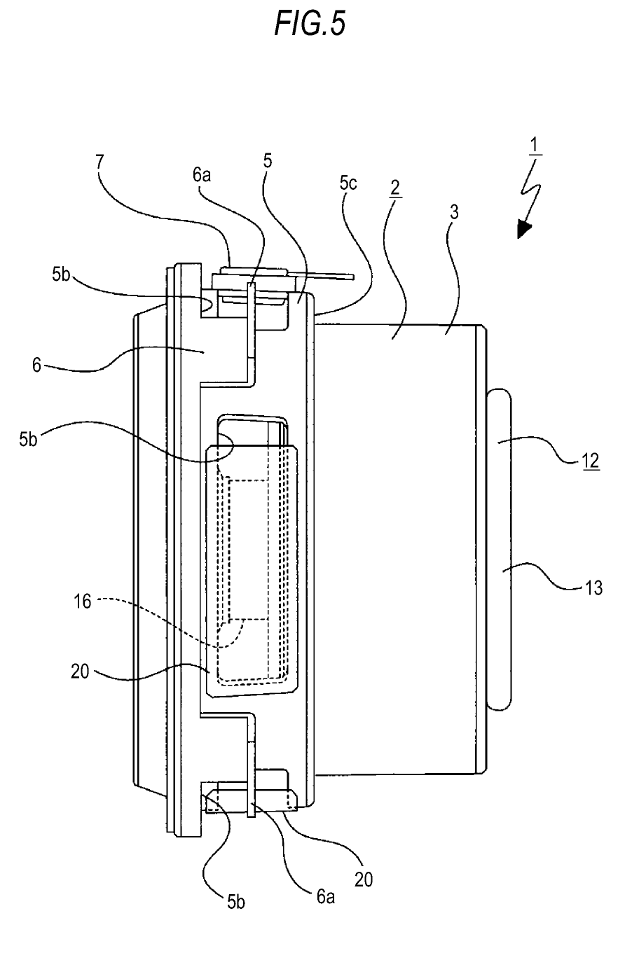

The speaker unit 1 includes necessary respective parts made of metal materials arranged inside a frame 2 (refer to FIG. 3 to FIG. 5).

The frame 2 includes a small-diameter base portion 3 formed to have a cylindrical shape, a bottom portion 4 extending inward from an rear edge of the small-diameter base portion 3, a large-diameter base portion 5 connecting to a front edge of the small-diameter base portion 3 and protruding forward and a folded portion 6 formed to be folded 180 degrees from a front edge of the large-diameter base portion 5.

A central hole of the bottom portion 4 is formed as an insertion hole 4a.

The large-diameter base portion 5 has a slightly larger diameter than the small-diameter base portion 3, which is connected to the front edge of the small-diameter base portion 3 through a step 5c facing front and back directions. Plural communicating holes 5b, 5b, . . . are formed on the large-diameter base portion 5 at equal intervals in a circumferential direction. The large-diameter base portion 5 has an opening 5a opening to a front direction, namely, an output direction of sound.

A terminal 7 is attached to an outer surface of the large-diameter base portion 5. The terminal 7 is provided as a terminal portion performing connection to the amplifier 60.

Mounting pieces 6a, 6a, . . . are provided on the folded portion 6 at equal intervals in the circumferential direction, and the mounting pieces 6a, 6a, . . . protrude outward. The speaker unit 1 is fixed to not shown mounting portions of the active speaker device 70 with the mounting pieces 6a, 6a, . . . , for example, being screwed.

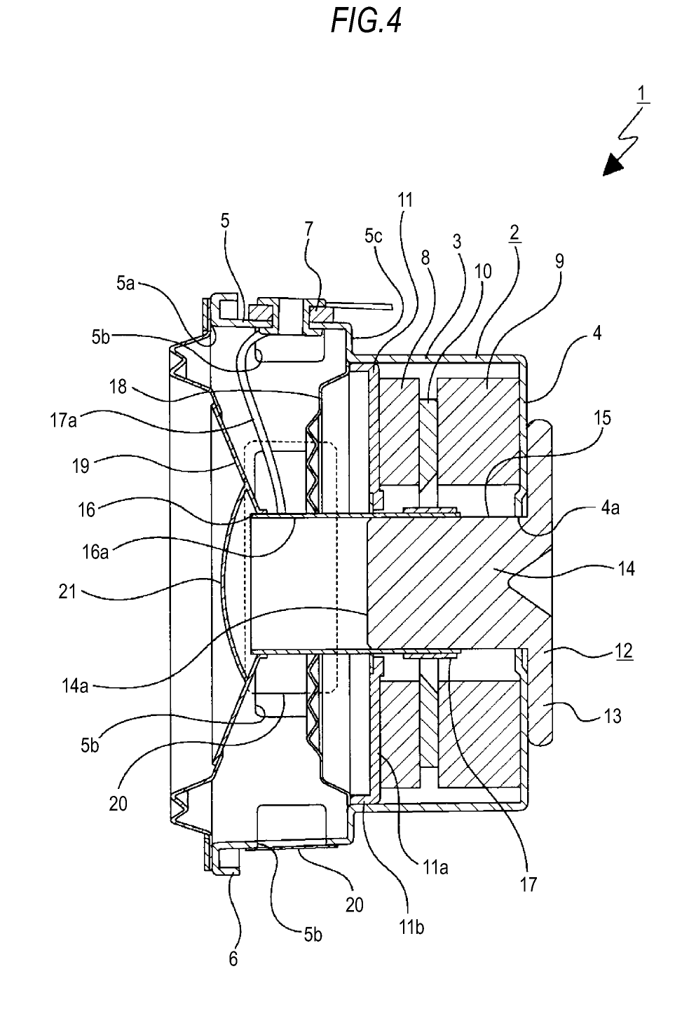

Inside the small-diameter base portion 3, a first magnet 8 and a second magnet 9 both formed in an annular shape are arranged with an interval in a front-and-back direction (refer to FIG. 4). An annular plate 10 is arranged between the first magnet 8 and the second magnet 9, a rear surface of the first magnet 8 is fixed to a front surface of the plate 10 as well as a front surface of the second magnet 9 is fixed to a rear surface of the plate 10. A rear surface of the second magnet 9 is fixed to the bottom portion 4 of the frame 2.

A sub-plate 11 is fixed on an upper surface of the first magnet 8. The sub-plate 11 includes a base portion 11a and a fixing protrusion 11b protruding forward from an outer peripheral portion of the base portion 11a, and the fixing protrusion 11b is fixed to an inner peripheral surface at a front end of the small-diameter base portion 3.

The first magnet 8, the second magnet 9, the plate 10 and the sub-plate 11 are connected in a coaxial state and arranged inside the small-diameter base portion 3.

A yoke 12 is fixed to a rear surface of the bottom portion 4 of the frame 2. The yoke 12 includes an approximately disk-shaped base surface portion 13 and an insertion arrangement portion 14 protruding forward from the center of the base surface portion 13 which are integrally formed, in which the insertion arrangement portion 14 is formed in an approximately column shape.

A front surface of the base surface portion 13 in the insertion arrangement portion 14 is fixed to a rear surface of the bottom portion 4, and the insertion arrangement portion 14 is inserted inside the frame 2 from an insertion hole 4a of the bottom portion 4. The insertion arrangement portion 14 is arranged inside the small-diameter base portion 3 in a state of being inserted through a center hole of the second magnet 9, a center hole of the plate 10, a center hole of the first magnet 8 and a center hole formed in the base portion 11a of the sub-plate 11.

A space between the insertion arrangement portion 14 of the yoke 12 and the first magnet 8 as well as the second magnet 9 is formed as a magnetic gap 15.

A coil bobbin 16 having a cylindrical shape is arranged inside the frame 2 and a portion on the rear end side of the coil bobbin 16 is supported by the insertion arrangement portion 14 so as to fit onto the insertion arrangement portion 14. The coil bobbin 16 can be moved (can be shifted) to the axial direction (front-and-back direction) with respect to the insertion arrangement portion 14. Air existing in an internal space 16a of the coil bobbin 16 will be compressed air with the movement of the coil bobbin 16.

A coil 17 is wound around an outer peripheral surface at a rear end of the coil bobbin 16. The coil 17 is led from portions where end portions 17a, 17a at both sides are wound and connected to the terminal 7. The coil 17 is arranged in the magnetic gap 15.

The coil 17 is arranged in the magnetic gap 15, thereby forming a magnetic circuit by the first magnet 8, the second magnet 9, the yoke 12 and the coil 17.

A damper 18 is attached at an intermediate part of the coil bobbin 16 in the axial direction. The damper 18 is formed to be thin in an approximately annular-shape which can be elastically deformed, in which an inner peripheral portion is attached to an outer peripheral surface of the coil bobbin and an outer peripheral portion is attached to an inner surface of the step 5c of the frame 2. The damper 18 is elastically deformed when drive current is supplied to the coil 17 and the coil bobbin 16 is moved in the axial direction, having a function of suppressing excessive movement of the coil bobbin 16 in the axial direction.

A cone 19 is attached at a front end of the coil bobbin 16. An inner peripheral portion of the cone 19 is attached to the front end of the coil bobbin 16 and an outer peripheral portion thereof is attached to an outer peripheral portion of the opening 5a in the large-diameter base portion 5 of the frame 2. Therefore, the cone 19 vibrates so that a front end serves as a fulcrum with the movement of the coil bobbin 16 in the axial direction.

Attachment members 20, 20, . . . respectively blocking portions of communicating holes 5b, 5b, . . . are attached to the frame 2.

The attachment members 20, 20, . . . are made of, for example, nonwoven paper, nonwoven fabric, sponge and so on, namely, materials having air permeability. Additionally, the attachment members 20, 20, . . . are desirable to be formed by using materials with low reflection coefficient of sound other than metal materials.

As portions of the communicating holes 5b, 5b, . . . are blocked by the attachment members 20, 20, . . . , the opening area of portions not blocked by the attachment members 20, 20, . . . in the communicating holes 5b, 5b, . . . is set to be, for example, 40% or less of the area of the cone 19.

A cap 21 is attached to a position close to the inner circumference of the cone 19, and the internal space 16a is blocked by the cap 21 and the insertion arrangement portion 14. The cap 21 is made of, for example, metal materials such as magnesium and aluminum, cloth materials, paper materials and so on. The cap 21 can be attached to the front end of the coil bobbin 16.

### [Operation of the Speaker Unit]

When drive current is supplied to the coil 17 in the speaker unit 1 configured as the above, thrust is generated in the magnetic circuit, the coil bobbin 16 is moved in the front-and-back direction (axial direction) and the cone 19 vibrates with the movement of the coil bobbin 16. At this time, sound output in proportion to electric current, namely, output of sound outputted from the digital music player 100 and amplified by the amplifier 60 is performed.

When the coil bobbin 16 is moved, the damper 18 is elastically deformed with the movement of the coil bobbin 16, and electromagnetic brake is not generated as the speaker unit 1 is the current-driven type speaker unit.

However, the attachment members 20, 20, respectively blocking portions of the communicating holes 5b, 5b, . . . are attached to the frame 2 in the speaker unit 1, therefore, the opening area of portions not blocked by the attachment members 20, 20, . . . in the communicating holes 5b, 5b, . . . is smaller than the area of the cone.

As pressure inside the frame 2 on the back surface side of the cone 19 is increased accordingly, oscillation in the lowest resonance frequency domain is suppressed.

When sound is outputted from the speaker unit 1, outputted sound is likely to be reflected sound by being reflected at portions made of metal materials where sound reflection coefficient is high, which may cause deterioration in sound quality. Therefore, the attachment members 20, 20, . . . are made of materials having low reflection coefficient of sound other than metal materials, thereby suppressing generation of reflected sound and improving sound quality.

### [Outline]

As described above, the attachment members 20, 20, . . . respectively blocking portions of the communicating holes 5b, 5b, . . . are attached to the frame 2 in the active speaker device 70 and the speaker unit 1.

As the opening area of portions not blocked by the attachment members 20, 20, . . . in the communicating holes 5b, 5b, . . . is smaller than the area of the cone, pressure inside the frame 2 on the back surface side of the cone 19 is high, which can suppress oscillation due to resonance in the lowest resonance frequency domain and improve sound quality.

As the opening area of portions not blocked by the attachment members 20, 20, . . . in the communicating holes 5b, 5b, . . . is 40% or less of the area of the cone 19, the high pressure inside the frame 2 on the back surface side of the cone 19 can be secured and the effect of suppressing oscillation in the lowest resonance frequency domain can be increased.

The attachment members 20, 20, . . . are made of materials having air permeability as described above. As the attachment members 20, 20, . . . are made of materials having air permeability, occurrence of so-called wind noise which can be generated as abnormal noise can be suppressed, which can improve sound quality due to reduction of noise.

Additionally, the attachment members 20, 20, . . . can be made of materials not having air permeability. As the attachment members 20, 20, . . . are made of materials not having air permeability, pressure inside the frame 2 is liable to be high, which can further increase the effect of suppressing oscillation in the lowest resonance frequency domain.

Note that specific shapes and structures of respective components shown in the above embodiment are merely examples of embodiments when carrying out the technology, and the technical scope of the present disclosure should not be interpreted in a limitative manner according to the examples.

It should be understood by those skilled in the art that various modifications, combinations, sub-combinations and alterations may occur depending on design requirements and other factors insofar as they are within the scope of the appended claims or the equivalents thereof.

What is claimed is:

1. A speaker unit performing sound output in proportion to electric current by current driving comprising:
a frame having an opening which opens at least to an output direction of sound;
a magnet arranged inside the frame and formed in an annular shape;
a yoke including a shaft-shaped insertion arrangement portion which is inserted into a center of the magnet and arranged there;
a coil bobbin formed in a cylindrical shape and can be moved in an axial direction of the insertion arrangement portion in a state where part of the coil bobbin is fitted onto the insertion arrangement portion of the yoke;
a coil wound around an outer peripheral surface of the coil bobbin and arranged in a magnetic gap formed by the magnet and the insertion arrangement portion of the yoke;
a damper having elasticity and connected between the frame and the coil bobbin; and
a cone connected to the coil bobbin at an inner peripheral portion and fixed to an opening edge of the opening of the frame at an outer peripheral portion, which vibrates with movement of the coil bobbin,
wherein a communicating hole communicating the inside to the outside is formed at the frame, and
a portion of the communicating hole is blocked by an attachment member.

2. The speaker unit according to claim 1,
wherein an opening area of a portion not blocked by the attachment member in the communicating hole is 40% or less of an area of the cone.

3. The speaker unit according to claim 1,
wherein the attachment member is made of materials other than metal materials.

4. The speaker unit according to claim 1,
wherein the attachment member is made of materials having air permeability.

5. The speaker unit according to claim 1,
wherein the attachment member is made of materials not having air permeability.

6. An active speaker device comprising:
an amplifier performing sound output in proportion to electric current by current driving; and
a speaker unit outputting sound amplified by the amplifier,
wherein the speaker unit performing sound output in proportion to electric current by current driving includes
a frame having an opening which opens at least to an output direction of sound,
a magnet arranged inside the frame and formed in an annular shape,
a yoke including a shaft-shaped insertion arrangement portion which is inserted into a center of the magnet,
a coil bobbin formed in a cylindrical shape and can be moved in an axial direction of the insertion arrangement portion in a state where part of the coil bobbin is fitted onto the insertion arrangement portion of the yoke,
a coil wound around an outer peripheral surface of the coil bobbin and arranged in a magnetic gap formed by the magnet and the insertion arrangement portion of the yoke,
a damper having elasticity and connected between the frame and the coil bobbin, and
a cone connected to the coil bobbin at an inner peripheral portion and fixed to an opening edge of the opening of the frame at an outer peripheral portion, which vibrates with movement of the coil bobbin, in which a communicating hole communicating the inside to the outside is formed at the frame, and a portion of the communicating hole is blocked by an attachment member.
